(19) United States
(12) Patent Application Publication
(10) Pub. No.: US 2014/0143147 A1
(43) Pub. Date: May 22, 2014

(54) TRANSACTION FEE NEGOTIATION FOR CURRENCY REMITTANCE

(71) Applicants: Rajesh Poornachandran, Beaverton, OR (US); Gyan Prakash, Beaverton, OR (US); Selim Aissi, Menlo Park, CA (US)

(72) Inventors: Rajesh Poornachandran, Beaverton, OR (US); Gyan Prakash, Beaverton, OR (US); Selim Aissi, Menlo Park, CA (US)

(21) Appl. No.: 13/997,207

(22) PCT Filed: Dec. 20, 2011
(86) PCT No.: PCT/US11/66043

§ 371 Date: Jan. 28, 2014

(51) Int. Cl. G06Q 20/40

(52) U.S. Cl. CPC G06Q 20/40
USPC 705/44

(57) ABSTRACT

Described herein are systems and methods for conducting remittances transactions with mobile and other electronic devices. In some embodiments, the systems and methods permit a user of a mobile or other electronic device to query multiple service providers for fee information from a single location. And in some instances, such fee information is provided to the user in real time.

### FIELD

The present disclosure relates to currency remittance transactions, including but not limited to currency remittance transactions initiated by a user of a mobile or other electronic device.

### BACKGROUND

Currency remittance transactions involve the transfer of money from one location to another. Such transactions may occur, for example, between businesses, financial institutions, individuals, merchants, and combinations thereof. In a typical remittance transaction, a party wishing to remit money (hereafter, the “payer”) engages a service provider to facilitate the transaction with the party to whom the remittance is being made (hereafter, the “payee”). In exchange, the service provider typically charges the payer and/or payee a transaction fee.

To determine its transaction fee for executing a particular currency remittance transaction, a service provider may take into account a number of variables related to the transaction. For example, a service provider may consider factors such as its relationship with and proximity to the payer and payee, the nature of the parties involved (e.g., individuals, businesses, etc.), and the amount of money that will be transferred. Different service providers weigh these and other variables differently. As a result, the transaction fee for executing a particular currency remittance transaction may vary considerably between service providers.

With the recent increase in electronic and mobile commerce, systems and applications have been developed that that allow commercial transactions, including currency remittance, to be conducted using mobile and other electronic devices. However, current systems and applications supporting currency remittance are generally specific to a single service provider. Moreover, such applications typically require one or both of the parties to a proposed transaction, i.e., the payer and payee, to establish a personal account with the service provider associated with the application.

As a result, a party interested in conducting a currency remittance transaction using a mobile or other electronic device may have to establish multiple accounts and install multiple applications in order to shop for a desirable transaction fee for conducting a remittance transaction. This can be inconvenient and time consuming, particularly because rate information obtained in this manner may not be up to date. That is, it may not reflect the current offer of a particular service provider.

### BRIEF DESCRIPTION OF THE DRAWINGS

Features and advantages of embodiments of the claimed subject matter will become apparent from the following detailed description and the drawings, wherein like numerals depict like parts, and in which:

FIG. 1 illustrates an exemplary system overview of a system for negotiating transaction fees for currency remittance consistent with non-limiting embodiments of the present disclosure.

FIG. 2 illustrates exemplary system architecture for negotiating transaction fees for currency remittance consistent with non-limiting embodiments of the present disclosure.

FIG. 3 illustrates an exemplary timeline for the connection and authorization of a remittance transaction in accordance with non-limiting embodiments of the present disclosure.

FIG. 4 is a flow diagram illustrating an exemplary method of operating a transaction fee negotiation system in accordance with non-limiting embodiments of the present disclosure.

Although the following detailed description will proceed with reference being made to illustrative embodiments, many alternatives, modifications, and variations thereof will be apparent to those skilled in the art.

### DETAILED DESCRIPTION

As used herein, the term “mobile device” means any of a wide variety of portable electronic devices, including but not limited to cell phones, electronic readers, handheld game consoles, mobile internet devices, portable media players, personal digital assistants, smart phones, ultra-mobile PCs, netbooks and notebook computers.

The phrase, “other electronic devices” is used herein to broadly refer to the wide swath of electronic devices that may be used to conduct currency remittance transactions, but which may not fall into the narrower (but still broad) purview of a mobile device. Non-limiting examples of other electronic devices include automated teller machines (ATM's), desktop computers, wired telephones, kiosks, and public computer terminals.

As used herein, the term, “real time” when used in reference to a system or method that receives data means that the system or method updates information at the same or substantially the same rate as it receives data. In some embodiments, the system receiving data is substantially in sync with the data that is maintained and sent by a transmitting system with which the system receiving the data is in communication. The term “substantially in sync” means that the system receiving the data is greater than or equal to about 95% in sync with data maintained and sent by the transmitting system. In some embodiments, the system receiving the data is greater than or equal to about 99% in sync with the data maintained and sent by the transmitting system.

The terms, “remittance,” “currency remittance,” “remittance transaction,” “money transfer,” and the like are interchangeably used herein to refer to financial transactions in which currency is transferred from one location to another. Non-limiting examples of such transactions include person-to-person (P2P) transactions, person-to-merchant (P2M) transactions, merchant to merchant transactions (M2M), and electronic banking (e-banking) transactions. As will be described in detail below, such remittance transactions may be initiated and/or conducted using mobile or other electronic devices. In some embodiments of the present disclosure, remittance transactions are initiated using a mobile device.

The present disclosure relates to systems and methods for conducting currency remittance transactions with mobile and other electronic devices. In some embodiments, the systems and methods described herein provide a convenient way to conduct financial transactions that involve currency remittance. For example, the systems and methods of the present disclosure may facilitate fee-based currency remittance transactions by enabling individuals and businesses to inspect transaction fee offers from multiple service providers with respect to a proposed remittance transaction. The systems and methods of the present disclosure may also include one or more security features that enhance the security of currency remittance transactions that are initiated by and/or conducted using a mobile or other electronic device.

The letter “n” is occasionally used as a subscript in connection with an element described in the figures. In such instances, it should be understood that n is a non-zero integer. Thus, for example, the expression “element Xₙ” should be interpreted as indicating that one (X₁) or a plurality element X's can be present. Accordingly, n may equal 1, 2, 3, 4 . . . 100 . . . 1000 . . . 10000 . . . or more, including all positive integer values between and/or above the aforementioned numbers. With this in mind, it should be understood that while the present disclosure may refer to an element in the singular, e.g., element Xₙ, such expressions should be interpreted as also encompassing the plural form.

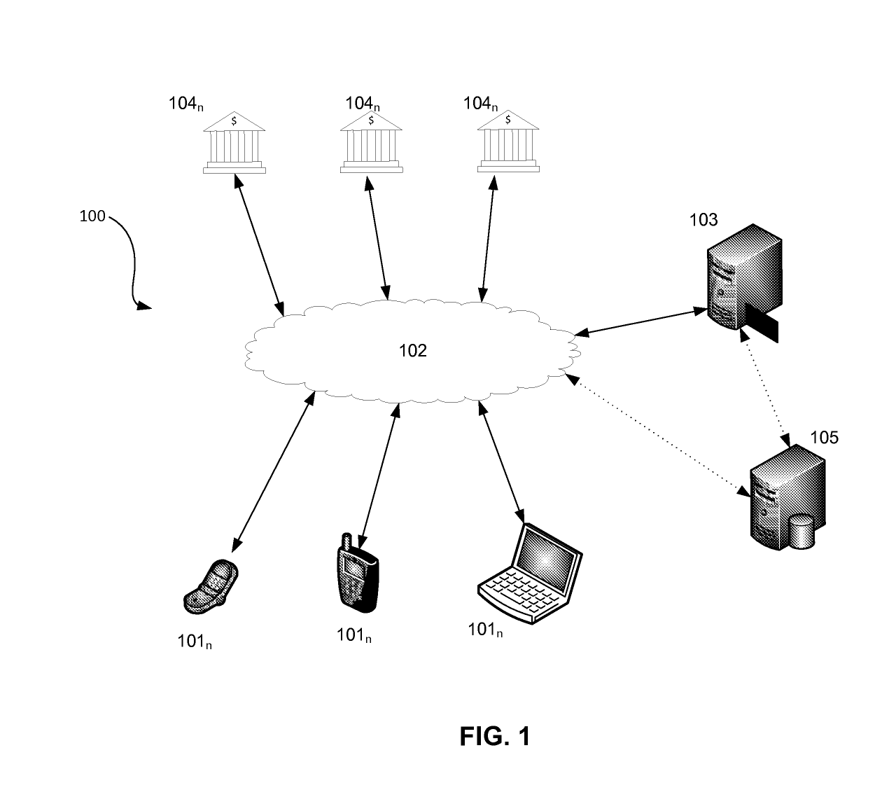

FIG. 1 is a block diagram illustrating a remittance transaction system 100 (hereafter, “system 100”) in accordance with non-limiting embodiments of the present disclosure. System 100 generally includes one or more devices 101ₙ. Devices 101ₙ may include at least one mobile or other electronic device, as defined above. In some embodiments, devices 101ₙ include at least one mobile device selected from cell phones, electronic readers, handheld game consoles, mobile internet devices, portable media players, personal digital assistants, smart phones, ultra-mobile PCs, netbooks and notebook computers. In further non-limiting embodiments, devices 101ₙ include at least one mobile phone, at least one smart phone, and combinations thereof. While the non-limiting example in FIG. 1 depicts three devices 101ₙ, it should be understood that any number of mobile or other electronic devices may be included in the systems and methods of the present disclosure.

In system 100, devices 101ₙ may bi-directionally communicate with transaction server 103 via network 102. Network 102 may be any network that carries data. As examples of suitable networks that may be used as network 102 in accordance with the present disclosure, non-limiting mention is made of the internet, private networks, virtual private networks (VPN), public switch telephone networks (PSTN), integrated services digital networks (ISDN), digital subscriber link networks (DSL), wireless data networks (e.g., cellular phone networks), combinations thereof, and other networks capable of carrying data. In some non-limiting embodiments, network 102 includes at least one of the internet, at least one wireless network, and at least one cellular telephone network.

Transaction server 103 may be executed on a single server machine or a number of server machines, which may be co-located or distributed geographically. In operation, transaction server 103 receives remittance transaction information from devices 101ₙ via network 102. Without limitation, remittance transaction information may include the identity of the payer, the amount, the source of to-be-remitted funds (such as but not limited to the payer's bank account), the identity of the payee, the destination of the to-be-remitted funds (such as but not limited to the payee's bank account), and combinations thereof. Of course, other information relevant to the remittance transaction may also be included. For example, remittance transaction information may further include information regarding the geographical location of the payee and/or payer, the geographical location of the source and/or destination of funds, frequency of the proposed transaction (e.g., in the case of a recurring remittance transaction), combinations thereof, and other information.

In addition to receiving remittance transaction information from devices 101ₙ, transaction server 103 may be in bi-directional communication with one or a plurality of service providers 104ₙ. Without limitation, service providers 104ₙ may include financial institutions, such as but not limited to banks, brokerages, credit unions, hedge funds, and the like, and/or businesses that offer currency remittance services. As non-limiting examples of such businesses, mention is made of WESTERN UNION® and MONEYGRAM®, which at the time this disclosure was filed were engaged in the money transfer business. It should be understood that service providers 104ₙ are entities that are capable of actually performing a proposed remittance transaction.

In some embodiments, the systems and methods described herein are fully electronic, and service providers 104ₙ correlate to servers or other electronic data communications equipment associated with a financial institution and/or a business that offers currency remittance services. It is noted that while the non-limiting example shown in FIG. 1 depicts three service providers 104ₙ, any number of service providers may be used in the systems and methods of the present disclosure.

Transaction server 103 may communicate all or a portion of the remittance transaction information received from devices 101ₙ to service providers 104ₙ. In response, any or all of service providers 104ₙ may communicate to transactions server 103 the transaction fee the service provider would charge for executing the proposed currency remittance transaction. In addition, one or more of service providers 104ₙ may communicate other information related to the execution of the proposed transaction, such as but not limited to exchange rate information (e.g., in the case of an international money transfer) and velocity information (i.e., the estimated time to complete the transaction). In this way, transaction server 103 may obtain up to date information regarding the transaction fees that would be charged from a variety of service providers in connection with the execution of a proposed currency remittance transaction. And in some instances, transaction server 103 may receive such transaction fee information in real time.

Alternatively or additionally, transaction server 103 may be configured to periodically request transaction fee information from service providers 104ₙ. For example, transaction server 103 may be configured such that it periodically transmits hypothetical currency remittance transactions to service providers 104ₙ. Such hypothetical currency remittance transactions may be, for example, transactions that are representative of frequently requested remittance transactions initiated by users of devices 101ₙ. As a result, transaction server 103 can periodically obtain transaction fee information from service providers 104ₙ for the execution of transactions that are frequently requested remittance transactions. Transaction server 103 may store such transaction fee information in a database, which may be updated when transaction server 103 receives new transaction fee information from one or more of service providers 104ₙ.

Transaction fee data stored in such a database may not be as accurate or up to date as a transaction fee quote that is generated by service providers 104ₙ in response to a remittance transaction initiated by a user of devices 101ₙ. However, the storage of transaction fee data (e.g., for hypothetical/representative transactions) in a database (e.g., within transaction server 103) may mean that such information can be delivered to devices 101ₙ, more quickly than a transaction fee quote generated by service providers 104ₙ in response to a specific remittance transaction initiated by devices 101ₙ. As a result, the transaction fee data in the database may be used to quickly provide an estimate of the transaction fee that may be charged by service providers 104ₙ for a specific remittance transaction. In such instances, if a user of devices 101ₙ wishes to proceed further with the transaction, he/she may authorize the transaction based on the estimate of the transaction fee(s). Alternatively, a transaction fee quote specific to the proposed remittance transaction may be generated by service providers 104ₙ, as described above.

Transaction server 103 may be further configured to maintain and/or store data regarding entities that are using or otherwise participating in system 100. In some embodiments, for example, transaction fee server may store the transaction history of users of devices 101ₙ. Transaction fee server 103 may use such stored data to transmit advertisements, other information, and combinations thereof to devices 101ₙ. Such advertisements and other information may, for example, be sent based on the transaction history of a user of devices 101ₙ.

Regardless of how the transaction fee information is generated, transaction fee server 103 may communicate such information to devices 101ₙ via network 102. As a result, users of devices 101ₙ may receive up to date and/or real time transaction fee quotes from multiple financial institutions regarding the execution of a proposed remittance transaction. Likewise, users of devices 101ₙ may receive estimated transaction fees generated using hypothetical remittance transactions that are representative of a proposed remittance transaction. Upon receiving this transaction fee information, a user of devices 101ₙ may select a particular service provider, and the selected service provider may carry out the proposed remittance transaction. System 100 may employ one or more security features to enhance the security of currency remittance transactions initiated through devices 101ₙ. In some embodiments, for example, system 100 may include authentication server 105, which functions to authenticate various elements relevant to remittance transactions initiated through devices 101ₙ. In such embodiments, devices 101ₙ may initiate a proposed remittance transaction by communicating identification information relevant to the transaction to authentication server 105. As a non-limiting example of such identification information, mention is made of identifying indicia that can serve as positive identification of devices 101ₙ. Such identifying indicia may include, for example, the international mobile equipment identity (IMEI) of devices 101ₙ, trusted platform module (TPM) tokens, combinations thereof, and other identifying indicia. In addition to such identifying indicia, devices 101ₙ may communicate other information relevant to the proposed transaction, such as but not limited to the amount, velocity, payer/payee information, source/destination of funds, geographic information, and combinations thereof.

Upon receiving identifying information and/or other information from devices 101ₙ, authentication server 105 may conduct a validation operation on the provided information. For example, authentication server 105 may authenticate the supplied information using an authentication protocol that is suitable for authenticating a financial transaction. As a non-limiting example of such a protocol, mention is made of remote attestation. Alternatively or additionally, authentication server 105 may compare identifying indicia supplied by devices 101ₙ in connection with a proposed remittances transaction to identifying indicia supplied previously to authentication server 105 by such devices in connection with the establishment of an account.

In addition to validating the identity of one or more of the parties to the proposed remittance transaction, authentication server 105 may validate other information related to the transaction. For example, authentication server 105 may validate and/or verify: the source and destination of funds; whether the amount to be remitted in the transaction is present in the source of funds (e.g., the payer's bank account); whether the transaction complies with relevant securities laws; whether the transaction frequency and/or number of transactions has/have been exceeded; and combinations thereof.

If authentication server 105 is unable to validate one or more aspects of the information provided by devices 101ₙ, the proposed remittance transaction may be denied. Conversely, the transaction may be allowed to proceed if validation of the information provided by devices 101ₙ succeeds.

In addition to validating the information supplied by devices 101ₙ, authentication server 105 may supply security indicia to devices 101ₙ and transaction server 103. Non-limiting examples of such security indicia include keys (e.g., public keys), cipher information (e.g., data encryption standard (DES), Triple data encryption standard (3DES), advanced encryption standard (e.g., AES-128, AES-192, AES-256), Rivest Cipher (RC), Kasumi, etc.), encrypted data, hash information (e.g., message digest (e.g., MD4), secure hash information (e.g., secure hash algorithm 1 (SHA-1), secure hash algorithm-X (SHA-X), etc.), combinations thereof, and other indicia. In some embodiments, such security indicia may be time bound, transaction bound, or a combination thereof. That is, the security indicia may only be valid for a period of time set by authentication server 105, for single remittance transaction, for a defined number of remittance transactions, or a combination thereof.

In some embodiments, the security indicia may constitute a shared secret between devices 101ₙ, authentication server 105, and transaction server 103. In such instances, devices 101₁-101ₙ, transaction server 103, and authentication server may “sign” their respective communications with the security indicia, thereby enhancing the security of the proposed transaction. For example, where devices 101ₙ and transaction server 103 communicate via one or more network packets, they may append or otherwise include the security indicia (e.g., a time bound key, a hash, a cipher, etc.) to/in one or more of such packets. Devices 101₁-101ₙ, authentication server 105, and transaction server 103 may then inspect communications (data packets) from one another for security indicia. If the security indicia included in the communication matches the security indicia on file, the authenticity of communications from devices 101n, authentication server 105, and/or transactions server 103 may be assured.

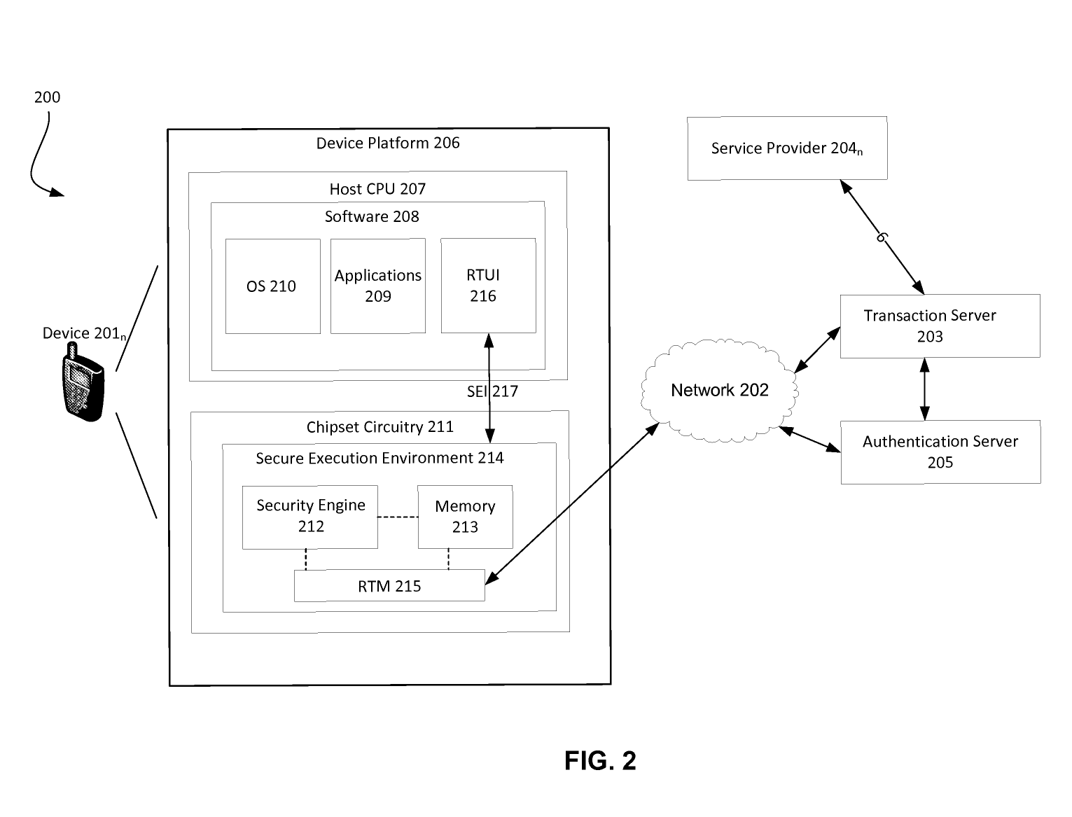

FIG. 2 is a block diagram illustrating an exemplary architecture of a remittance transaction system in accordance with non-limiting embodiments of the present disclosure. As shown, remittance transaction system 200 (hereafter, “system 200”) includes devices 201ₙ, network 202, transaction server 203, service providers 204ₙ, and authorization server 205. Devices 201ₙ include at least one device platform 206, such as a cell phone platform, an electronic reader platform, a handheld game console platform, a mobile internet device platform, a portable media player platform, a personal digital assistant platform, a smart phone platform, an ultra-mobile PC platform, a netbook platform, a notebook computer platform, and combinations thereof. While a single device 201ₙ is depicted in the non-limiting example shown in FIG. 2, it should be understood that any number of devices may be used in system 200.

Device platform 206 includes at least one host processor 207 running software 208, such as, for example, applications 209 and operating system (OS) 210. Device platform 206 further includes chipset circuitry 211.

Chipset circuitry 211 may include integrated circuit chips, such as those selected from integrated circuit chipsets commercially available from the assignee of the subject application, although other integrated circuit chips may also or alternatively be used. “Circuitry”, as used in any embodiment herein, may comprise, for example, singly or in any combination, hardwired circuitry, programmable circuitry, state machine circuitry, and/or firmware that stores instructions executed by programmable circuitry.

In some embodiments, chipset circuitry 211 includes security engine 212 and at least one memory 213. Security engine 212 may be, for example, a microcontroller that is embedded within chipset circuitry 211 and apart from host processor 207. As a result, security engine 212 and its underlying code (e.g., firmware or software) may be implemented and/or executed in an environment that is isolated from host processor 207, operating system 210, and/or a basic input operating system (BIOS) of device 201ₙ.

In non-limiting embodiments of the present disclosure, the software and/or firmware of security engine 212 may be executed from a portion of memory 213 that is protected from host processor 207, operating system 210 and/or a BIOS of device 201ₙ. For example, the software and/or firmware of security engine 212 may be stored within data storage blocks of memory 213 that are hidden or otherwise inaccessible to host processor 207, operating system 210, or a BIOS of device 201ₙ. In some instances, such data blocks may be protected by a read only policy, such as a read only policy enforced by security engine 212 and/or by a unified memory access (UMA) mechanism that prevents direct access to such blocks by unauthorized software running on host processor 207. Such unauthorized software may include, for example, all or a portion of software 208, such as applications 209 and OS 210.

For the purpose of the present disclosure, storage blocks of memory 213 that are secured in this manner are referred to herein as secure storage. The combination of secure storage and security engine 212 is referred to herein as a secure execution environment, and is depicted in FIG. 2 as secure execution environment 214. Thus, it should be understood that secure execution environment 214 is a hardware block of chipset circuitry 211 that includes security engine 212 and secure storage (i.e. secured data blocks of memory 213).

Memory 213 may include one or more of the following types of memory: semiconductor firmware memory, programmable memory, non-volatile memory, read only memory, electrically programmable memory, random access memory, flash memory (which may include, for example, NAND or NOR type memory structures), magnetic disk memory, and/or optical disk memory. Additionally or alternatively, memory 213 may include other and/or later-developed types of computer-readable memory. In some embodiments, memory 213 can be local to host processor 207, local to security engine 212, or local to another embedded processor (not shown) within chipset circuitry 211.

Chipset circuitry 211 may further include a remittance transaction module 215 (“RTM 215”). Generally, and as shown in FIG. 2, RTM 215 is a software component that may reside and/or be executed within secure environment 214 of chipset circuitry 211. When a remittance transaction is initiated by device 201ₙ, RTM 215 functions to facilitate the secure authentication and execution of the proposed transaction. In this regard, RTM 215 may be configured to communicate with authentication server 205 and transaction server 203 via network 202. In some embodiments, RTM 215 independently communicates with such servers. That is, RTM 215 may communicate with authentication server 205 and transaction server 203 independently of other circuitry in system 200, such as but not limited to host processor 207.

In some non-limiting embodiments, the underlying code of RTM 215 is stored in memory 213. Accordingly, memory 213 may include RTM instructions stored thereon that when executed by a processor cause devices 201ₙ to perform functions consistent with the present disclosure. In further non-limiting embodiments, RTM instructions are stored in secure storage of memory 213. That is, memory 213 may include secure data blocks that are hidden or otherwise inaccessible to host processor 207, software 208, and/or a BIOS of device 201ₙ, as described above, wherein RTM instructions are stored within such secure data blocks.

RTM instructions may be executed by a processor, such as a processor embedded within chipset circuitry 211. In some non-limiting embodiments, the RTM instructions are executed by a processor within secure execution environment 214, as described above. When executed, the RTM instructions 214 cause chipset circuitry 211 to perform operations consistent with the present disclosure. Thus, for example, RTM instructions 214 when executed can cause chipset circuitry 211 to independently communicate with transaction server 203 and authorization server 205 via network 202. More specifically, RTM instructions 214 when executed may cause a processor embedded within chipset circuitry 211 to communicate with transaction server 203 and authorization server 205 via network 202.

Although security engine 212 and RTM 215 can be executed in secure execution environment 214, inputs to such elements may be made through authorized software running on host processor 207. To facilitate such communication, device platform 206 may include one or more secure engine interface 214 (SEI 217) that allows secure inputs to be made to security engine 212 and/or RTM 215. As non-limiting examples of interfaces that may be used as SEI 217, mention is made of secure buses, such as but not limited to an inter integrated circuit (IIC or I2C) bus.

In some embodiments, therefore, software 208 can include a remittance transaction user interface 216 (RTUI 216) operable to communicate inputs related to a proposed remittance transaction to RTM 215. In some embodiments, RTUI 216 is executed by a processor as an independent application on device platform 206. Alternatively, RTUI may be configured as a program that is run within the context of other software executed by host processor 207. For example, RTUI 216 may be an application that is run within operating system 210. Likewise, RTUI 216 may be a web-based application, i.e., an application run within a host web browser. Similarly, RTUI 216 may be provided as website code that is executed and/or read by a web browser. In such instances, the RTUI may be understood to be a web-based remittance transaction user interface (WBRTUI). Regardless of its nature, RTUI 216 may be understood to provide an interface through which users of device 201ₙ may send and receive inputs to/from RTM 215 related to a proposed remittance transaction.

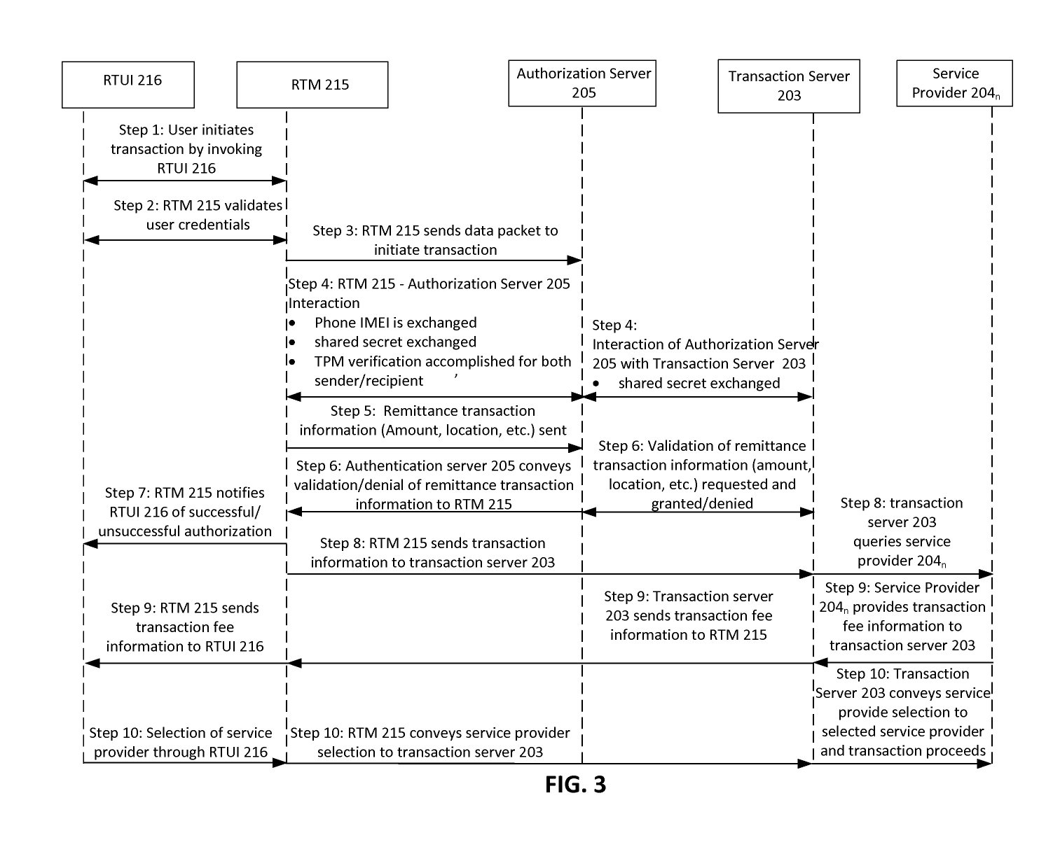

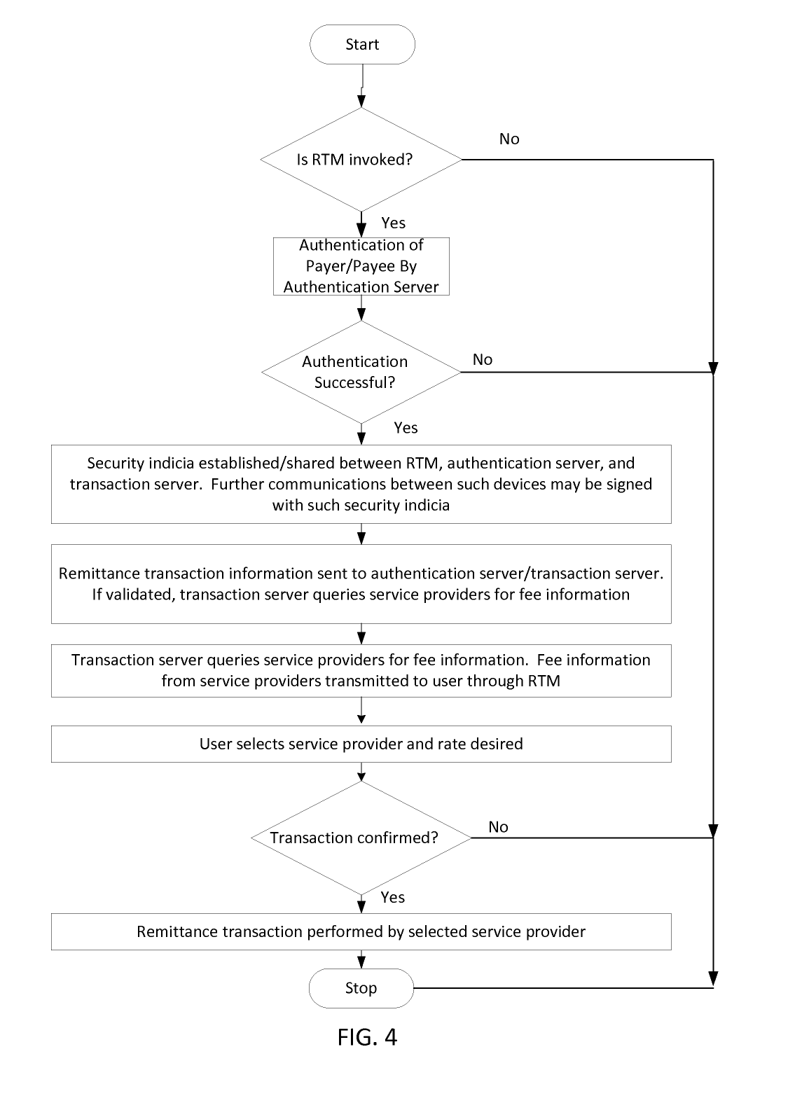

FIG. 3 provides a timeline illustrating a non-limiting example of the functions of and communication flow between various components of system 200 during the execution of a remittance transaction initiated through device(s) 201ₙ. Similarly, FIG. 4 provides a flow diagram of a remittance transaction executed in accordance with non-limiting embodiments of the present disclosure. While FIGS. 3 and 4 depict different aspects of the systems and methods of the present disclosure (e.g., exemplary communication flow (FIG. 3) vs. exemplary method of operation (FIG. 4)), they generally relate to the same system and so are collectively described below.

As shown in the non-limiting examples of FIGS. 3 and 4, a user of device 201ₙ may initiate a remittance transaction by invoking RTUI 216. Invocation of RTUI 216 may be accomplished by a user of device 201ₙ, for example, by causing RTUI 216 to run on host processor 207, by inputting data into RTUI 216, or through another means.

RTUI 216 may be configured to accept data inputs containing information relevant to remittance transactions. Thus, for example, RTUI 216 may be configured to accept inputs containing information regarding the identity of the payer/payee, the amount, the source of funds, the destination of funds, the velocity of the proposed transaction (time of execution), recurrence of the proposed transaction, geographic location, combinations thereof, and other information. RTUI 216 may also be configured to accept inputs containing security information, such as a username, a password, a pin, combinations thereof, and the like.

As shown in FIG. 2, RTUI 216 may communicate such data inputs via SEI 217 to secure execution environment 214 within chipset circuitry 211. For example, RTUI 216 may communicate data inputs via SEI 217 to security engine 212, which may forward such data inputs to RTM 215. Alternatively or additionally, RTUI 217 may communicate data inputs directly to RTM 215 via SEI 217.

Upon receiving data inputs from RTUI 216, RTM 215 may validate the credentials of the user of device 201ₙ and/or the input data provided through software 208 (e.g., RTUI 216). With respect to the former, RTM 215 may validate the identity of a user of device 201ₙ by analyzing security information transmitted to it by RTUI 216 in connection with the proposed transaction. As noted above, such security information may include a username, password, pin code, biometric information (e.g., a thumb print, retinal scan, etc.) and combinations thereof. With respect to the latter, RTM 215 may validate data inputs from RTUI 216 by analyzing such inputs for identifying features, such as key information, cipher information, encryption information, hashes, secure hashes, and the like, which may be appended to or otherwise included in communications from RTUI 216.

If RTM 215 cannot validate the credentials of the user and/or the input data provided by RTUI 216, RTM 215 may terminate the proposed remittance transaction. If validation succeeds, however, RTM 215 may initiate communication with authentication server 205 with respect to the proposed transaction. For example, RTM 215 instructions may send one or more data packets to authentication server 205. Non-limiting examples of such data packets include network packets such as ethernet packets, internet protocol (IP) packets, short message service (SMS) data packets, transmission control protocol (TCP) data packets, combinations thereof, and other data packets. In some embodiments, RTM 215 initiates communication with authentication server 205 by sending SMS packets to authentication server 205 via network 202.

Once communication is established between RTM 215 and authentication server 205, RTM 215 may communicate identification information relevant to the proposed remittance transaction to authentication server 205. As a non-limiting example of such identification information, mention is made of indicia that can serve as positive identification of device 201ₙ, such as those previously described in connection with FIG. 1. Thus for example, identification information may include the international mobile equipment identity (IMEI) of device 201ₙ, trusted platform module (TPM) tokens, a user name, password, pin, biometric information, combinations thereof, and other identifying indicia.

Upon receiving identification information from RTM 215, authentication server 205 may attempt to validate such identification information using one or more authentication protocols. In some embodiments, for example, authentication server 205 may authenticate the identification information supplied by RTM 215 using an authentication protocol that is suitable for authenticating a financial transaction. As a non-limiting example of such a protocol, mention is made of remote attestation. Alternatively or additionally, authentication server 205 may compare the identification information (e.g., indicia) supplied by RTM 215 to identifying indicia previously supplied previously to authentication server 205 by device 201ₙ, e.g., in connection with the establishment of an account.

If authentication server 105 is unable to validate one or more aspects of the identification information provided by RTM 205, authentication server 205 may deny the proposed transaction. If the identification information is successfully validated by authentication server 205, however, the transaction may be allowed to proceed further.

In this regard, authentication server 205 may, upon successful validation of the identification information supplied by RTM 215, generate or otherwise establish security indicia that may be used by the various components of system 200 in connection with the proposed remittance transaction. Non-limiting examples of such security indicia include keys, cipher information, encrypted data, hash information, secure hash information, combinations thereof, and other indicia as previously described in connection with FIG. 1. In some non-limiting embodiments, such security indicia is time bound and/or transaction bound, as previously described. In one non-limiting embodiment, the authentication server 205 generates or otherwise issues one or more time bound keys for use in connection with the proposed transaction.

Once authentication server 205 generates security indicia, it may share such security indicia with RTM 215 and transaction server 203. In such instances, the security indicia generated and shared by authentication server 205 may be considered a shared secret between RTM 215, authentication server 205, and transaction server 203. As a result, RTM 215, transaction server 203, and authentication server may “sign” communications regarding a proposed remittance transaction with the security indicia, thereby enhancing the security of the proposed transaction. For example, where RTM 215, authentication server 205 and transaction server 203 communicate via one or more network packets, they may append or otherwise include the security indicia within one or more of such packets. As a result, RTM 215, authentication server 205, and/or transactions sever 203 may confirm the authenticity of such communications by comparing the security indicia included in such communications with the security indicia generated and previously shared by authentication server 205. In this way, security of the communications between RTM 215, authentication server 205, and/or transactions server 203 can be enhanced.

Before or after it receives security indicia from authentication server 205, RTM 215 may transmit remittance transaction information to authentication server 205. Remittance transaction information may include, for example, information regarding the source/destination of funds (e.g., the payer/payee's account), the amount, velocity information, recurrence information, and/or other information, as previously described in connection with FIG. 1. In non-limiting embodiments, RTM 215 sends remittance transaction information after it receives security indicia from authentication server 205 has provided security indicia to RTM 215. In those instances, RTM 215 may append or otherwise include the security indicia to the communications containing the remittance transaction information (e.g., to one or more data packets), thereby enhancing the security of such communications.

Regardless of when RTM 215 sends remittance transaction information, authentication server 205 may validate such information by communicating with transaction server 203. For example, authentication server 205 may communicate remittance transaction information to transaction server 203. Upon receiving the remittance transaction information from authentication server 205, transaction server may communicate with participating financial institutions (e.g., the payer's bank, the payee's bank, another company that will provide the source of funds and/or receive the funds, etc.) In this way transaction server 203 can learn, for example, the amount of funds in the payers account, whether transmission information (e.g., routing numbers) for the participating financial institutions are valid, whether the payer has exceeded a transaction limit imposed by his/her financial institution, etc.

After communicating with the participating financial institutions, transaction server may transmit its findings to authentication server 205 for validation. If one or more of transactions server 203's findings is inconsistent with the details of the proposed remittance transaction (e.g., the to-be remitted amount is not available in the payers account), validation may fail and authentication server 205 may prevent the transaction from proceeding further.

Conversely, if the findings of transaction server 205 are consistent with the data inputs of the proposed transaction, then authentication server 205 can validate the remittance transaction information and the transaction may proceed further. In either case, a user of device 201ₙ may be notified of the successful or unsuccessful authorization via RTUI 215, as shown in FIG. 3.

Once authorization server 205 validates the identification and remittance transaction information, RTM 215 can communicate the details of the proposed remittance transaction to transaction server 203. Transaction server 203 may then query service provider 204ₙ (and/or a plurality of service providers) and obtain information regarding transaction and other fees service provider 204ₙ would charge to execute the proposed transaction. Transaction server 203 may then communicate the fee information received to RTM 215, which in turn may communicate the fee information to RTUI 216.

Subsequently, a user of device 201ₙ may select a service provider to execute the proposed transaction, and input that selection into RTUI 216. RTUI 216 may then communicate that selection through SEI 214 to RTM 215, which in turn may communicate the selection to transaction server 203. Transaction server 203 may then communicate the selection to the selected service provider (e.g., one of service providers 204ₙ), and the selected service provider can execute the transaction.

As should be understood from the foregoing, the systems and methods of the present disclosure can provide a convenient, safe, and secure manner of conducting remittances transactions via mobile or other electronic devices. Indeed, the described methods may employ a combination of hardware and software security solutions to enhance the security of such transactions and their underlying communications. Moreover, the systems and methods can allow users of mobile and other electronic devices to shop for and obtain the best rates for remittance transactions, based on the remittance amount, the payer/payee location, recurrence, velocity, combinations thereof, and other factors relevant to the transaction.

Other embodiments of the present disclosure will be apparent to those skilled in the art from consideration of the specification and practice of the inventions disclosed herein. It is intended that the specification be considered as exemplary only, with a true scope and spirit of the invention being indicated by the following claims.

1-29. (canceled)

30. A method comprising:
executing a remittance transaction user interface (RTUI) on a host processor of at least one device, said RTUI being configured to accept data inputs relevant to a remittance transaction;
transmitting said data inputs to a secure execution environment via at least one secure interface, wherein the secure execution environment is inaccessible to said host processor and located within chipset circuitry of said device;
transmitting said data inputs from said secure execution environment to at least one authentication server;
executing an authentication operation on said data inputs with said at least one authentication server, wherein:
if said authentication operation fails, said authentication server terminates said remittance transaction; and
if said authentication operation succeeds, transmitting said data inputs from said secure execution environment to at least one service provider capable of performing said remittance transaction.

31. The method of claim 30, further comprising executing a remittance transaction module (RTM) within said secure execution environment.

32. The method of claim 30, further comprising executing a remittance transaction module (RTM) within said secure execution environment, wherein said secure execution environment comprises at least one secure memory and at least one security engine, wherein the secure memory and at least one security engine are isolated from said host processor.

33. The method of claim 30, further comprising transmitting said data inputs from said secure execution environment to at least one transaction server, and transmitting said data inputs from said at least one transaction server to said at least one service provider.

34. The method of claim 33 further comprising issuing security indicia with said at least one authentication server and sharing said security indicia with said at least one authentication server, said at least one transaction server, and said secure execution environment, wherein communications between said secure execution environment, said at least one authentication server, and said at least one transaction server comprise said security indicia.

35. The method of claim 33, further comprising receiving fee information from said at least one service provider, wherein said fee information correlates to a fee said at least one service provider would charge for executing said remittance transaction.

36. The method of claim 35, further comprising providing said fee information to said UI of said at least one device in real time.

37. The method of claim 30, wherein said data inputs comprise information regarding a source of funds to-be-remitted in the remittance transaction and an amount of funds to-be-remitted, the method further comprising validating said source of funds and said amount of funds with said at least one authentication server.

38. The method of claim 37, wherein said at least one authentication server validates said source of funds and said amount of funds prior to transmitting said data inputs from said secure execution environment to said at least one service provider.

39. The method of claim 30, wherein all communications from and to said RTUI in regard to said remittance transaction flow through said secure execution environment.

40. A computer readable medium having remittance transaction instructions, which when executed by a processor causes:
said processor to receive at a secure execution environment data inputs relevant to a remittance transaction, wherein said data inputs are transmitted to said secure execution environment via at least one secure interface, said secure execution environment being located in chipset hardware of a device comprising a host processor, said secure execution environment being inaccessible to said host processor;
said processor to transmit said data inputs from said secure execution environment to at least one authentication server;
said at least one authentication server to perform at least one authentication operation on said data inputs; and
upon receiving authentication of said data inputs, said processor to transmit said data inputs from said secure execution environment to at least one service provider capable of performing said remittance transaction.

41. The computer readable medium of claim 40, wherein said secure execution environment comprises at least one secure memory and at least one security engine, both of which are isolated from said host processor, said remittance transaction instructions being at least partially stored on said at least one secure memory;
wherein said remittance transaction instructions when executed further cause the processor to execute at least one remittance transaction module in said secure execution environment.

42. The computer readable medium of claim 40, wherein said remittance transaction instructions when executed further cause:
said processor to transmit said data inputs from said secure execution environment to at least one transaction server;
said at least one transaction server to transmit said data inputs to said at least one service provider.

43. The computer readable medium of claim 42, wherein said remittance transaction instructions when executed further cause:
said at least one authentication server to issue and share at least one security indicia with said at least one authentication server, said at least one transaction server, and said secure execution environment; and
said secure execution environment, said at least one authentication server, and said at least one transaction server to include said at least one security indicia in their respective communications with one another.

44. The computer readable medium of claim 42, wherein said remittance transaction instructions when executed further causes said secure execution environment to receive fee information from said at least one service provider, wherein said fee information correlates to a fee said at least one service provider would charge for executing said remittance transaction.

45. The computer readable medium of claim 44, wherein said remittance transaction instructions when executed cause said secure execution environment to transmit in real time said fee information to an unsecured user interface (UI) of said device.

46. The computer readable medium of claim 40, wherein said data inputs comprise information regarding a source of funds to-be-remitted in the remittance transaction and an amount of funds to-be-remitted, and said remittance transaction instructions when executed further cause said at least one authentication server to validate said source of funds and said amount of funds.

47. The computer readable medium of claim 46, wherein said remittance transaction instructions when executed cause said at least one authentication server to validate said source of funds and said amount of funds prior to causing said secure execution environment to transmit said data inputs to said at least one service provider.

48. The computer readable medium of claim 40, wherein said remittance transaction instructions when executed causes all communications from and to said device in regard to said remittance transaction to flow through said secure execution environment.

49. A system, comprising at least one device, the at least one device comprising:
a host processor;
chipset circuitry comprising a secure execution environment that is inaccessible to said host processor; and
a secure interface between a remittance transaction user interface (RTUI) executed on said device and said secure execution environment; and
at least one authentication server;
wherein:
said RTUI is operable to accept data inputs relevant to a remittance transaction and transmit said data inputs to said secure execution environment via said secure interface;
said secure execution environment is operable to transmit said data inputs to said at least one authentication server for authentication;
said at least one authentication server is operable to execute at least one authentication operation on said data inputs; and
said secure execution environment is further operable to transmit, upon receiving authentication of said data inputs, said data inputs to at least one service provider capable of performing said remittance transaction.

50. The system of claim 49, further comprising at least one remittance transaction module (RTM) executed in said secure execution environment.

51. The system of claim 49, further comprising at least one remittance transaction module (RTM) executed within said secure execution environment, wherein said secure execution environment comprises at least one secure memory and at least one security engine, wherein the secure memory and at least one security engine are isolated from said host processor.

52. The system of claim 49, wherein said secure execution environment is further operable to transmit said data inputs to at least one transaction server, and said at least one transaction server is operable to transmit said data inputs to said at least one service provider.

53. The system of claim 52, wherein said authentication server is operable to issue security indicia and share said security indicia with said at least one transaction server and said secure execution environment; and
wherein said secure execution environment, said at least one authentication server, and said at least one transaction server include said security indicia in their respective communications to one another.

54. The system of claim 52, wherein said secure execution environment is further operable to receive fee information from said at least one service provider, wherein said fee information correlates to a fee said at least one service provider would charge for executing said remittance transaction.

55. The system of claim 54, wherein said data inputs comprise information regarding a source of funds to-be-remitted in the remittance transaction and an amount of funds to-be-remitted; and
said at least one authentication server is operable to validate said source of funds and said amount of funds.

56. The system of claim 49, wherein all communications from and to said RTUI in regard to said remittance transaction flow through said secure execution environment.
